(19) United States
(12) Patent Application Publication
(10) Pub. No.: US 2005/0130094 A1
(43) Pub. Date: Jun. 16, 2005

(54) Orthodontic accessory arch bar

(76) Inventor: Neil John Graham, Long Beach, CA (US)

Correspondence Address: Neil John Graham, 6017 Lido Lane, Long Beach, CA, 90803, US

(21) Appl. No.: 10/733,728

(22) Filed: Dec. 12, 2003

(51) Int. Cl. A61C 3/00

(52) U.S. Cl. 433/20

(57) ABSTRACT

An orthodontic accessory arch bar for orthodontic therapy which is adapted for attachment to the buccal surface of a fixed orthodontic appliance. The accessory arch bar is comprised of wires heavier than orthodontic arch wires which gives the accessory arch bar greater control over the width and form of the dental arch. The orthodontic accessory wire may be configured to widen or narrow the dental arch, coordinate the bite, precisely shape the dental arch, open or close the anterior bite, and correct a cant of the anterior occlusal plane.

### FIELD OF THE INVENTION

The present device relates to an accessory arch bar which is used to form the dental arch of an orthodontic patient when it is attached outwardly adjacent to the arch wire of an orthodontic appliance.

### BACKGROUND OF THE INVENTION

The orthodontic procedures, today, for straightening teeth involve the placement of orthodontic brackets with attached orthodontic arch wires on the external or labial surfaces of the teeth. The labial surfaces of the teeth are the most common locations for fixed orthodontic appliances because of ease of access for the dentist and comfort for the patient. Orthodontic treatment is comprised of a succession of orthodontic arch wires from small diameter round wires, to larger round wires, to larger wires rectangular in cross-section. Orthodontic arch wires have been chosen in size, shape, and composition primarily for individually and mutually aligning the teeth and exert very little formation pressure over the width and shape of the dental arch, especially in the molar areas. Even the larger rectangular cross-section orthodontic arch wires have a small immediate affect upon the width of the dental arch in the molar areas. Larger diameter wires have been used on the internal or lingual surfaces of the teeth. The formation, placement, and adjustment these lingual wires are more difficult than the labial wires because of the lingual location. When adjusted correctly the lingual wires have greater control over the molar width than the labial arch wires, but are in a more difficult area of the mouth to work in.

Early orthodontists realized that the upper and lower dental arches frequently didn't match each other during finishing of an orthodontic treatment and compensated for the weakness of the orthodontic arch wires by forming and coordinating the arch wires into the desired arch form early in treatment. Occlusion of the teeth in a normal, or Class 1, bite helps coordinate the bite; but correction of the bite to a Class 1 bite often doesn't occur until the end of orthodontic treatment which doesn't allow enough time for the occlusion to coordinate the bite. If coordination of the bite has not been accomplished by the end of treatment the orthodontic arch wires are not strong enough to quickly correct the bite and finish the case. Lingual arch wires can be more effective at this point and can have accessory wires added to them to widen the arch form; however, lingual arch accessory wires do not have precise control over the dental arch form.

### SUMMARY OF THE INVENTION

The present invention is directed to a labial accessory arch bar attached to a conventional orthodontic appliance. The arch bar piggybacks the orthodontic arch wire and extends, just as the arch does, on the labial of the teeth, from the molar area on one side of the mouth to molar area on the opposite side of the patient's mouth. The arch wire may be attached to the orthodontic appliance using the same ligature ties used to tie the arch wire to the orthodontic brackets. Elastomeric eyelets are an ideal method of ligation. The arch bar ends may be inserted into a headgear tube on the appliance or configured to engage the arch wire. In a preferred embodiment the arch bar is configured straight prior to placement on the orthodontic appliance which quickly widens the molar arch width which is particularly useful in widening of the upper arch width in the correction of a posterior dental cross bite.

In another embodiment of the present invention the accessory arch bar is configured into a planar circle with the ends crossing each other. The arch bar in this circular configuration will narrow the dental arch when placed on the orthodontic appliance. This narrowed form of the arch bar is particularly useful when used with an upper widening arch bar during correction of a posterior cross bite. In an alternative embodiment the arch bar can be used to quickly correct the tilt of an anterior occlusal plane. A tilted occlusal plane exists where the incisal edges of the front teeth appear either lower or higher on one side of the mouth when the teeth are viewed from the front of the patient's mouth. The accessary arch bar is configured in the desired arch form, but in the vertical plane the arch bar is bent upwards or downwards vertically in the direction and areas where the occlusal plane is to be altered.

In another embodiment upper and lower accessory arch bars are shaped into the desired dental arch form and coordinated with each other in order to quickly coordinate the bite during the finishing of an orthodontic treatment. In a further embodiment the accessory arch bar is configured to open or close an anterior bite. In an anterior open bite the arch bar is configured towards the occlusal area as it travels from the back of the mouth to the front prior to placement on the orthodontic appliance. In a deep over bite the arch bar is configured where it travels towards the gum line as it travels to the front of the mouth prior to ligating the arch bar to the appliance

### BRIEF DESCRIPTION OF THE DRAWINGS

FIG. 1 is a view of the accessory arch bar;

FIG. 2 is an occlusal view of the accessory arch bar placed on an orthodontic appliance;

FIG. 2A is a view of FIG. 2 through the plane of 2A-2A;

FIG. 2B is a view of FIG. 2 from the plane of 2B-2B;

FIG. 3 is an occlusal view of the accessory arch bar on an orthodontic appliance;

FIG. 3A is a view of FIG. 3 from the 3A-3A plane;

FIG. 3B is a of FIG. 3 from the 3B-3B plane;

FIG. 4A is a view of the accessory arch bar;

FIG. 4B is a view of the accessory arch bar;

FIG. 5A is a view of the accessory arch bar;

FIG. 5B is a view of the accessory arch bar;

FIG. 5C is a view of the accessory arch bar;

FIG. 6 is a view of the accessory arch bar on an orthodontic appliance;

FIG. 6A is a is a buccal view of FIG. 6 from the 6A-6A area;

FIG. 6B is a is a buccal view of FIG. 6 from the 6B-6B area;

FIG. 6C is an occlusal view of an accessory arch bar mounted to a bracket and arch wire;

FIG. 6D is an occlusal view of an accessory arch bar mounted to a bracket and arch wire;

FIG. 7 is a view of the accessory arch bar configured to correct a tilt of an occlusal plane;

FIG. 8 is a perspective view of FIG. 7 with the accessory arch bar in place;

FIG. 9 is a perspective view of an orthodontic appliance with a configured accessory wire;

FIG. 10 is a perspective view of FIG. 9 with the accessory arch bar in place;

FIG. 11 is a perspective view of a configured accessory arch bar;

FIG. 12 is a perspective view of FIG. 11 with the accessory arch bar in place;

FIG. 13A is a view of a configured accessory arch wire; and

FIG. 13B is a view of a configured accessory arch wire.

### DETAILED DESCRIPTION OF THE INVENTION

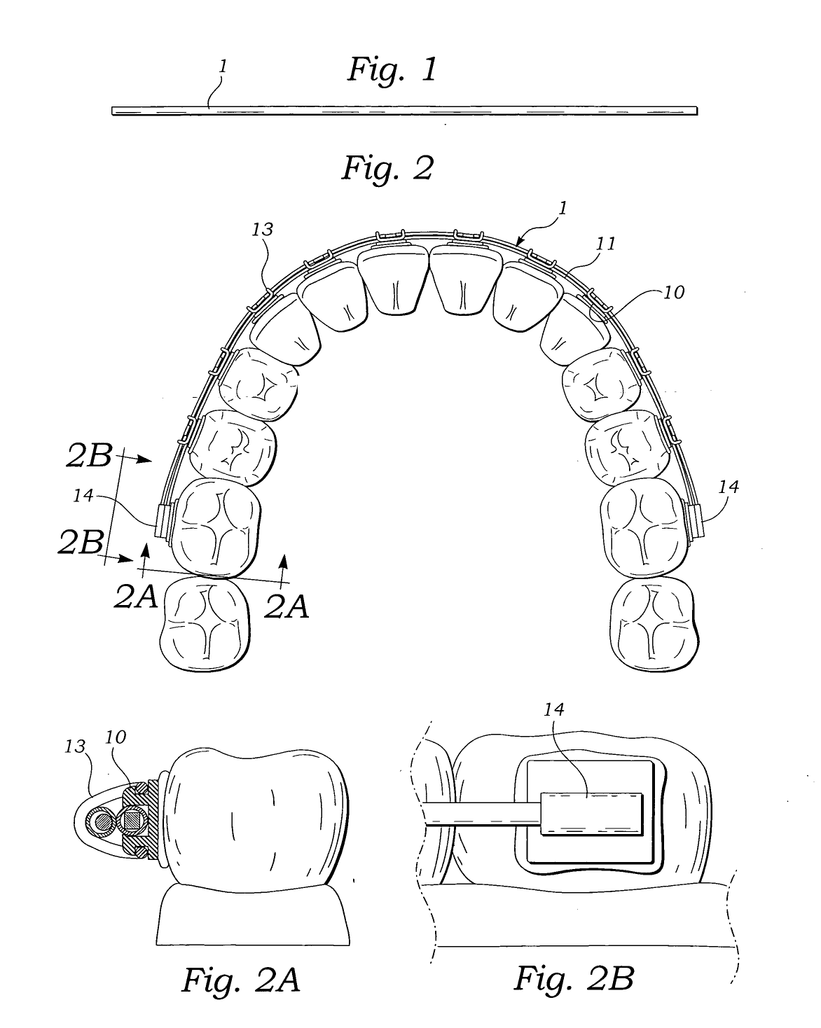

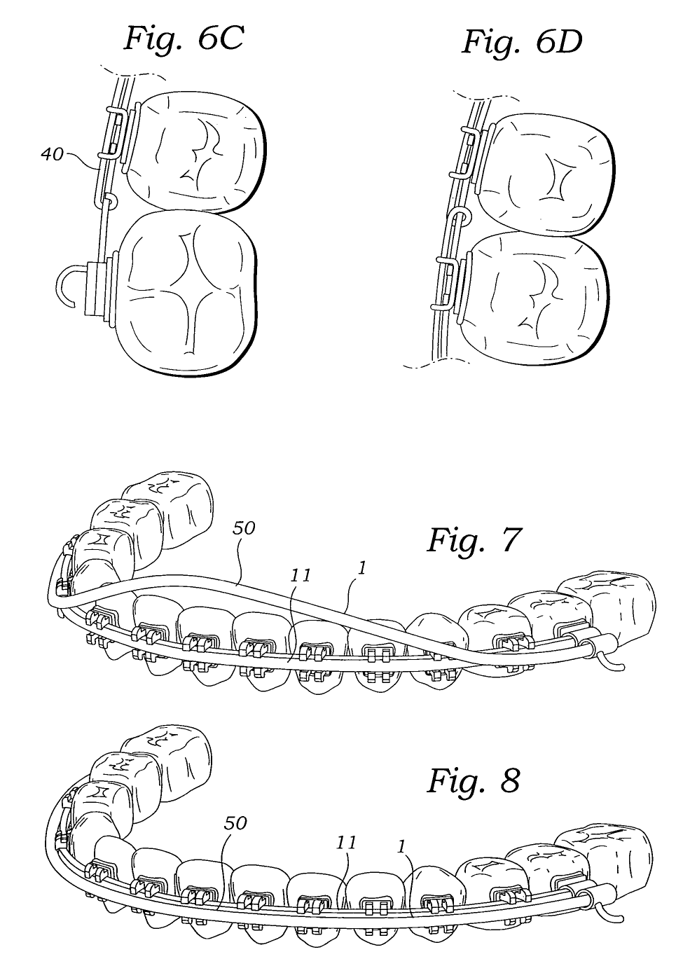

Referring to FIGS. 1-13 the accessory arch bar 1 is a wire of sufficient length to be attached, or piggy-backed to an installed orthodontic arch wire 11. The arch bar diameter can be 0.020-0.60 inch. The cross section of the arch bar is usually circular but can be other shapes, such as square or rectangular. The composition of the arch bar can be stainless steel. In a preferred embodiment the arch bar 1 is 0.027 inch in diameter and comprised of Ti beta 3 wire. In this embodiment the arch bar 1 is gentle for the patient, but because of its memory moves the teeth quickly.

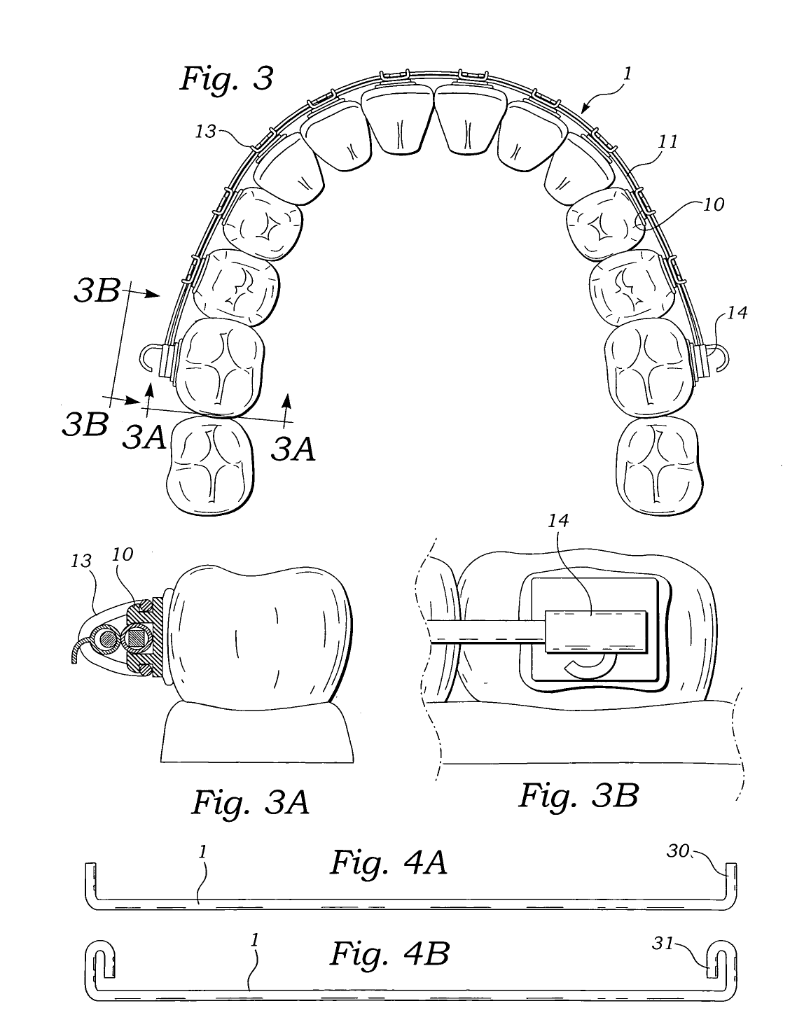

As shown in FIG. 2, an orthodontic appliance is comprised of brackets 10 placed on the outer surface of the patient's teeth 12. An arch wire 11 is connected to the brackets 10 and held in place with ties 13 which can be metal wire or elastomeric eyelets. In FIG. 3 the accessory arch bar 1 is shown attached to the orthodontic appliance using the same ties 13 which ligate the arch wire 11 to the orthodontic brackets 10. In another embodiment the arch bar 1 can be tied with separate ties 13 to the orthodontic appliance. The single tie 13 method is more efficient.

The end of the accessory arch bar 1 may be straight as in FIG. 1 and inserted into a head gear tube 14 as in FIGS. 3, 3A, and 3B, or configured as in FIGS. 4A and 4B. The accessory arch bar 1 end may be bent at a right angle 30 towards the teeth 12 when placed on the orthodontic appliance. This assures the arch bar 1 won't poke the patient and the end of the arch bar 1 won't slip out of the ties 13. In another configuration of the end 31 of the arch bar 1 the ends are looped towards the teeth 12 to circle the arch wire 11 or looped to engage an elastic hook part of an orthodontic bracket 10.

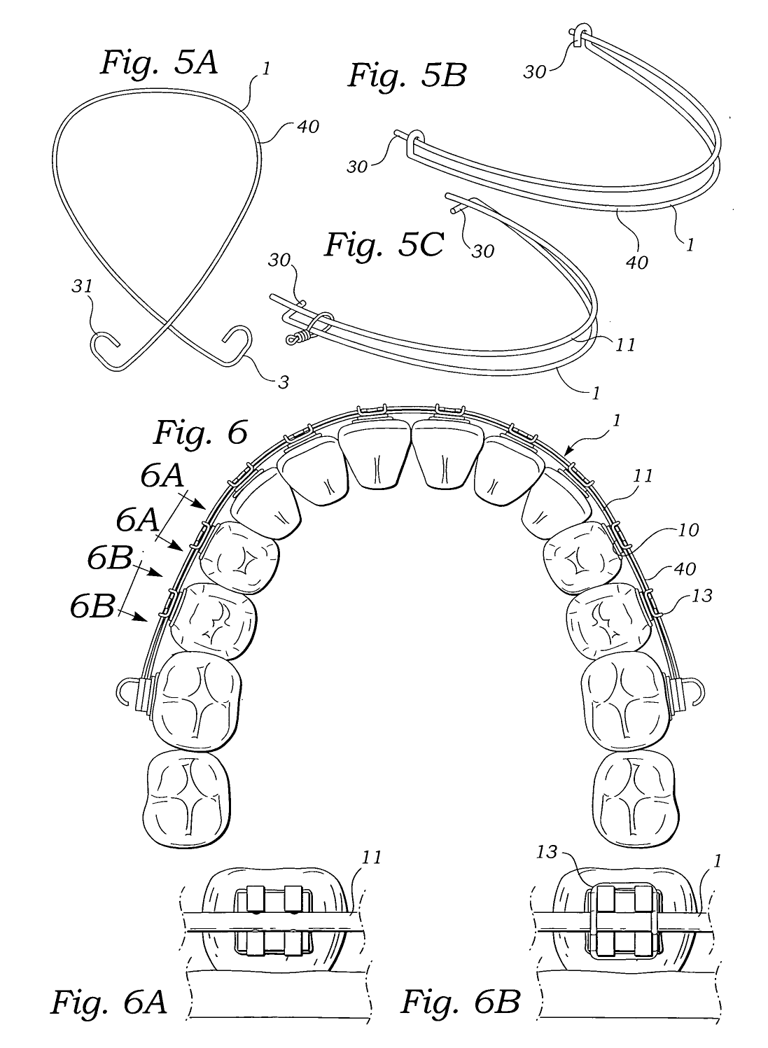

The arch bar 1 is configured in a variety of shapes to perform different functions. In one embodiment, FIGS. 1-4, the arch bar 1 is straight which widens the dental arch in the molar area when placed on the orthodontic appliance as shown in FIG. 3. This widening is effective in correcting a dental cross bite in the molar area. An example of a posterior cross bite is where an upper molar is towards the center of mouth in relation to the tooth it is occlusion with. In another embodiment in FIGS. 5A, 5B, and 5C the accessory arch bar 1 is configured in a planar arch wherein the arch bar ends cross each other. This embodiment, FIG. 5, will narrow the arch form when placed in the mouth. If the ends are looped 31, as in FIG. 4B, the placement of the appliance is easier. In many posterior cross bites the upper arch 11 width is too narrow and the lower molar arch width is too wide. By using the narrowing arch bar 40, FIG. 5A, on the lower arch with the widening upper arch bar 11, FIGS. 1-4, the correction of the posterior cross bite is facilitated and the dental occlusion goes into place more quickly.

In another embodiment in FIG. 7 the accessory arch bar 1 is first formed in a flat plane and to the desired shape of the dental arch. The arch bar 1 is bent 50 towards the gingival, or gum area, in order to move the teeth in this area in the direction of the bend 50. This bend towards the gingival 50 is effective in correcting a cant of the occlusal plane, which exists where the edges of the patient's teeth slant from left to right when the patient's teeth are viewed from a frontal direction. FIG. 8 shows the formed arch bar of FIG. 7 placed on the appliance.

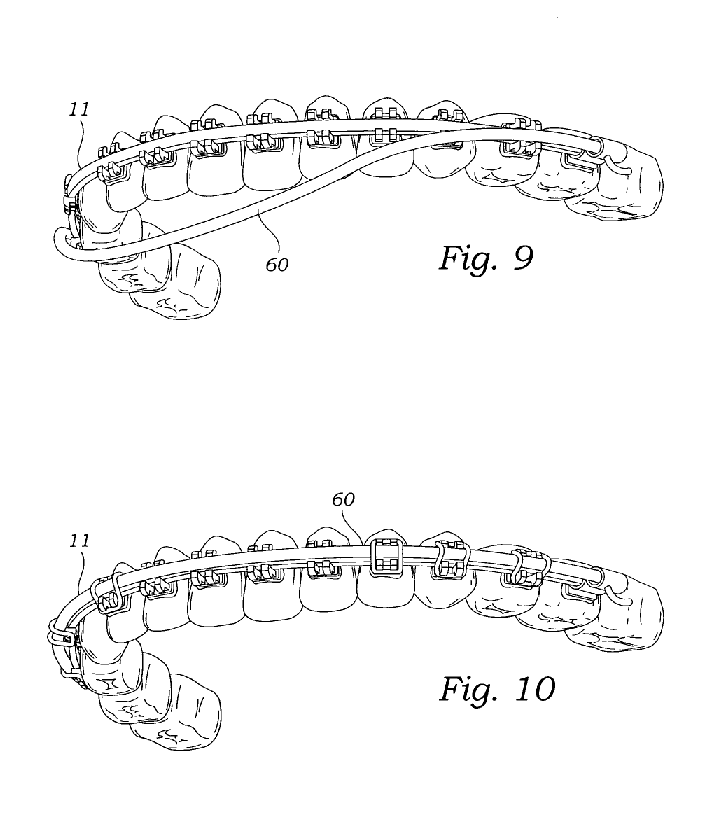

In another embodiment, in FIG. 9, the accessory arch bar 60 is configured to close an open bite of the front teeth which exists where the patient's upper and lower front teeth do not touch when they are biting together in occlusion. FIG. 9 shows an example of the arch bar 60 bent down, or away from the gums, moving the upper front teeth towards the lower front teeth when the arch bar 60 is engaged, as shown in FIG. 10. This anterior bend away from the gums 60 may also be done on the lower teeth.

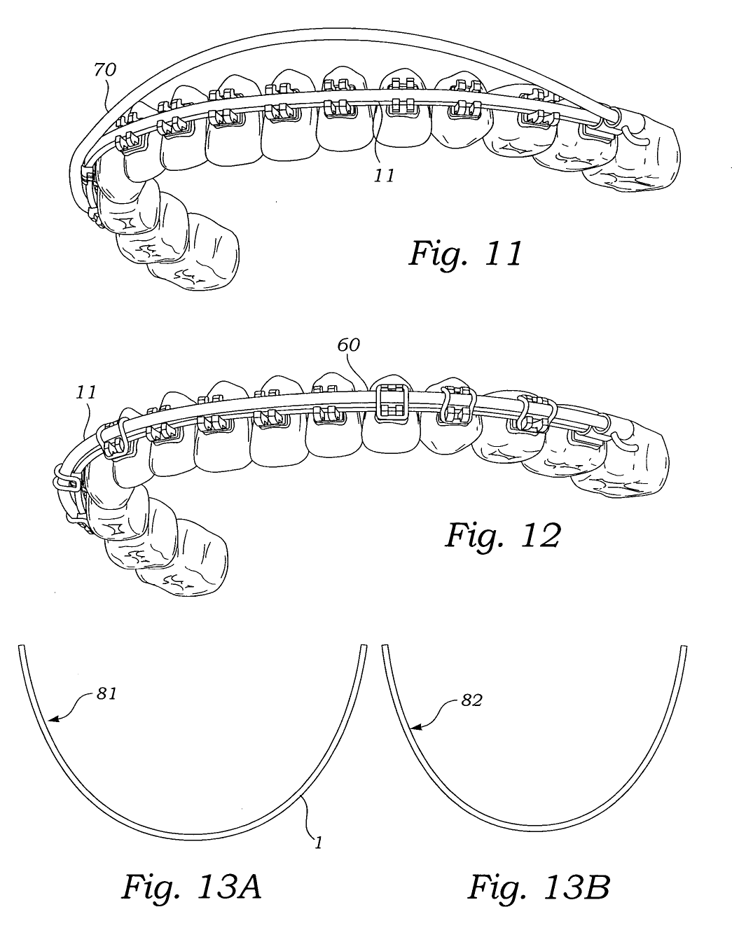

In a further configuration of the accessory arch bar 1, FIGS. 11 and 12, the accessory arch bar 1 is bent towards the gums as it travels towards the front of the mouth. When placed in the mouth, FIG. 12, the patient's anterior bite is opened in the case of a deep over bite which exists when the upper front teeth bite too deeply over the lower front teeth.

FIGS. 13A and 13B show another embodiment of the accessory arch bar 1, 81 and 82, wherein the upper and lower arch bars 1 are bent with the same arch form, or coordinated. Because of the strength of the arch bars 1 the upper and lower dental arches are quickly coordinated which facilitates the rapid finishing of active orthodontic treatment.

The composition of the accessory arch bar 1 is the same as orthodontic arch wires 11 which are primarily stainless steel, but include titanium wires. In a preferred embodiment the accessory arch bar 11 is 0.027 in. with a composition of 0.02% C, 10.12% Mo, 0.05% Fe, 0.01% N, 0.165% O, 0.01% H2, 5.48% Zr, 4.78% Sn, and balance Ti. This is known as Ti beta 3 and produces a super elastic accessory arch bar 1 which is gentle to the patient and because of superior memory produces rapid movement of the teeth.

The foregoing description of the present invention has been presented for the purpose of the illustration and description. Furthermore, the description is not intended to limit the invention to the use as described herein. Consequently, variations and modifications commensurate with the above teachings by someone skilled in the art at the time of the invention are within the scope of the present invention.

The embodiments described are intended to explain best modes known of practicing the invention at the time of the invention and are intended to include future uses of the invention such as a pending invention by the inventor wherein the accessory arch bar has an open coil spring assembly attached to it which transmits force via pulleys and cables to the opposing dental arch in bite correction.

1. An accessory arch bar attached to a fixed orthodontic appliance used during orthodontic treatment comprising:
a metal wire with a longitudinal body having opposing longitudinal ends, a cross-sectional diameter, and a longitudinal axis wherein the longitudinal body is straight which creates a dental arch widening when placed on an orthodontic appliance;
a cross-sectional diameter of 0.020 in. to 0.60 in.;
a longitudinal length similar to the length of an arch wire on a fixed orthodontic appliance; and
a tying means for attaching the accessory arch bar to an orthodontic appliance wherein a wire ligature or an elastomeric orthodontic module is used to attach the accessory arch bar to an orthodontic arch wire or directly to orthodontic brackets.

2. An accessory arch bar as in claim 1 wherein the ends of the accessory arch bar are formed at a right angle to the accessory arch bar long axis and directed towards the teeth when placed on the orthodontic appliance, which prevents irritation to the patient and dislodging of the ends of the accessory arch bar from the tying means

3. An accessory arch bar as in claim 1 wherein the composition of the accessory arch bar is comprised of metal compositions used for orthodontic arch wires.

4. An accessory arch bar wire as in claim 1 wherein the composition of the accessory arch bar is stainless steel.

5. An accessory arch bar as in claim 1 wherein the diameter of the accessory arch bar is 0.027 in.

6. An accessory arch bar as in claim 5 wherein the composition of the arch bar is Ti beta 3 wire which is super elastic and adjustable which is comfortable to the patient when placed on the orthodontic appliance, and yet moves the teeth quickly and effectively.

7. An accessory arch bar attached to a fixed orthodontic appliance used during orthodontic treatment comprising:
a metal wire with a longitudinal body having opposing longitudinal ends, a cross-sectional diameter, and longitudinal axis and the longitudinal body is curved on a flat plane wherein the ends approximate or cross over each, wherein when placed on the orthodontic appliance a narrowing of the dental arch is produced;
a cross-sectional diameter of 0.020 in. to 0.60 in.;
a longitudinal length similar to the length of an arch wire on a fixed orthodontic appliance; and
a tying means for attaching the accessory arch bar to an orthodontic appliance wherein a wire ligature or an elastomeric orthodontic module is used to attach the accessory arch bar to an orthodontic arch wire or directly to orthodontic brackets.

8. An accessory arch bar as in claim 7 wherein the ends of the accessory arch bar are formed at a right angle to the accessory arch bar long axis and directed towards the teeth when placed on the orthodontic appliance, which prevents irritation to the patient and dislodging of the ends of the accessory arch bar from the tying means.

9. An accessory arch bar as in claim 7 wherein the accessory arch bar ends are looped towards the teeth when placed on the orthodontic appliance wherein the loop encircles the arch wire or an orthodontic bracket hook.

10. An accessory arch bar is in claim 7 wherein the composition of the accessory arch bar is comprised of metal compositions used for orthodontic arch wires.

11. An accessory arch bar as in claim 7 wherein the diameter of the accessory arch bar is 0.027 in.

12. An accessory arch bar as in claim 11 wherein the composition of the arch bar is Ti beta 3 wire which is super elastic and adjustable which is comfortable to the patient when placed on the orthodontic appliance, and yet moves the teeth quickly and effectively.

13. An accessory arch bar attached to a fixed orthodontic appliance used during orthodontic treatment comprising:
a metal wire with a longitudinal body having opposing longitudinal ends, a cross-sectional diameter, and a longitudinal axis wherein the longitudinal body is formed on a flat plane into the desired dental arch form wherein when the arch bar is placed on the orthodontic appliance the dental arch is formed to the desired shape, this is most effective when accessory arch bars with similar arch forms are used in the upper and lower jaws simultaneously which coordinates the bite and fits the upper and lower teeth together during the orthodontic finishing process.

14. An accessory arch bar as in claim 13 wherein the ends of the accessory arch bar are formed at a right angle to the accessory arch bar long axis and are directed towards the teeth when placed on the orthodontic appliance, which prevents irritation to the patient and dislodging of the ends of the accessory arch bar from the tying means.

15. An accessory arch bar as in claim 13 wherein the ends of the accessory arch bar are looped towards the teeth when placed on the orthodontic appliance wherein the loop encircles the arch wire or an orthodontic bracket hook.

16. An accessory arch bar as in claim 13 wherein the composition of the accessory arch bar is stainless steel.

17. An accessory arch bar as in claim 13 wherein the diameter of the accessory arch bar is 0.027 in.

18. An accessory arch bar as in claim 17 wherein the composition of the arch bar is Ti beta 3 wire which is super elastic and adjustable which is comfortable to the patient when placed on the orthodontic appliance, and yet moves the teeth quickly and effectively.

19. An accessory arch bar attached to a fixed orthodontic appliance used during orthodontic treatment comprising:
a metal wire with a longitudinal body having opposing longitudinal ends, a cross-sectional diameter, and a longitudinal axis wherein the longitudinal body is configured on a flat plane into the desired dental arch form wherein the wire is curved either upwards or downwards away from the flat plane in the direction the occlusal plane of the teeth is to be moved, thus correcting a slant of an occlusal plane;
a cross-sectional diameter of 0.020 in. to 0.60 in.;
a longitudinal length similar to the length of an arch wire on a fixed orthodontic appliance; and
a tying means for attaching the accessory arch bar to an orthodontic appliance wherein a wire ligature or an elastomeric orthodontic module is used to attach the accessory arch bar to the orthodontic arch wire or directly to the orthodontic brackets.

20. An accessory arch bar as in claim 19 wherein the ends of the accessory arch bar are formed at a right angle to the accessory arch bar long axis and directed towards the teeth when placed on the orthodontic appliance, which prevents irritation to the patient and dislodging of the ends of the accessory arch bar from the tying means.

21. An accessory arch bar is in claim 19 wherein the composition of the accessory arch bar is comprised of metal compositions used for orthodontic arch wires.

22. An accessory arch bar wire as in claim 19 wherein the composition of the accessory arch bar is stainless steel.

23. An accessory arch bar as in claim 19 wherein the diameter of the accessory arch bar is 0.027 in.

24. An accessory arch bar as in claim 23 wherein the composition of the arch bar is Ti beta 3 wire which is super elastic and adjustable which is comfortable to the patient when placed on the orthodontic appliance, and yet moves the teeth quickly and effectively.

25. An accessory arch bar attached to a fixed orthodontic appliance used during orthodontic treatment comprising:
a metal wire with a longitudinal body having opposing longitudinal ends, a cross-sectional diameter, and longitudinal axis wherein the longitudinal body is configured to the shape of the desired dental arch and curves upwards or downwards from the occlusal plane as the wire proceeds towards the front of the mouth wherein the upper front teeth are moved correcting an open anterior bite or a deep over bite of the anterior teeth.
a cross-sectional diameter of 0.020 in. to 0.60 in.;
a longitudinal length similar to the length of an arch wire on a fixed orthodontic appliance; and
a tying means for attaching the accessory arch bar to an orthodontic appliance wherein a wire ligature or an elastomeric orthodontic module is used to attach the accessory arch bar to the orthodontic arch wire or directly to orthodontic brackets.

26. An accessory arch bar as in claim 25 wherein the ends of the accessory arch bar are formed at a right angle to the accessory arch bar long axis and directed towards the teeth when placed on the orthodontic appliance, which prevents irritation to the patient and dislodging of the ends of the accessory arch bar from the tying means.

27. An accessory arch bar is in claim 25 wherein the composition of the accessory arch bar is comprised of metal compositions used for orthodontic arch wires.

28. An accessory arch bar wire as in claim 25 wherein the composition of the accessory arch bar is stainless steel.

29. An accessory arch bar as in claim 25 wherein the diameter of the accessory arch bar is 0.027 in.

30. An accessory arch bar as in claim 29 wherein the composition of the arch bar is Ti beta 3 wire which is super elastic and adjustable which is comfortable to the patient when placed on the orthodontic appliance, and yet moves the teeth quickly and effectively.

31. A method of using an accessory arch bar for placing orthodontic force upon the teeth essentially consisting of:
forming a longitudinal arch bar into a pre-determined shape which produces orthodontic movement when attached to an orthodontic appliance;
placing the accessory arch bar adjacent to the cheek side of an arch wire of an orthodontic appliance; and
ligating the accessory arch bar to the orthodontic appliance.
